(19) United States
(12) Patent Application Publication
(10) Pub. No.: US 2006/0142997 A1
(43) Pub. Date: Jun. 29, 2006

(54) Predictive text entry and data compression method for a mobile communication terminal

(76) Inventors: Per Jakobsen, Hedehusene (DK); Claus Peter Nielsen, Copenhagen (DK); Jyrki Okkonen, Oulu (FI)

Correspondence Address: PERMAN & GREEN, 425 POST ROAD, FAIRFIELD, CT, 06824, US

(21) Appl. No.: 10/539,162

(22) PCT Filed: Dec. 27, 2002
(86) PCT No.: PCT/EP02/14777

§ 371 Date: Jan. 3, 2006

(51) Int. Cl. G06F 17/21

(52) U.S. Cl. 704/10

(57) ABSTRACT

The invention relates to mobile terminals. According to the invention, the communication terminal includes a predictive editor application for entering text. The editor is used for editing text for message handling, phonebook editing and searching, etc. The terminal further includes compression and/or decompression software. The invention further relates to a method of compressing data in a mobile terminal on which a language dependent dictionary is stored.

The present invention relates to terminals comprising a predictive editor application for entering text. Such a terminal can be a cellular or cordless phone, a personal digital assistant (PDA) or a communicator. The editor is used for editing text for message handling, phonebook editing and searching, etc. The invention further relates to a method of compressing data in a mobile terminal comprising the steps in which a language dependent dictionary is stored.

### BACKGROUND ART

Documents like EP 1031913 and EP1035712 disclose a mobile terminal having processor means controlling the display in accordance with the operation of the keypad. A selectable predictive editor program generates an output containing words matching a received string of ambiguous key strokes. The predictive editor program has a number of associated vocabularies including at least one language dependent dictionary and a dictionary receiving user defined inputs.

Language depended dictionaries such as stored in the mobile terminals known from EP 1031913 and EP1035712 needs to contain sufficient words to be able to handle the most commonly used words. Each language dependent dictionary (e.g. the English one) requires 100 kbyte memory space. The terminal usually stores several language dependent dictionaries for a plurality of natural languages, e.g. because the users are bi-lingual, or because the same software is used in countries with different official languages. The language dependent dictionaries and the disambiguating software may therefore use up to 600 Kbyte of memory space.

Mobile terminals as known from EP1031913 and EP1035712 have a number of language data sets, so-called language packs, stored thereon, that are used by the operating system (that is to say the menu control application) of the terminal to display text on display, e.g. in connection with menu control of the terminal. As a standard three to seven language packs for different natural languages are stored in the mobile terminal, so that users can choose which language they wish to use on the terminal, and so that the same software package can be used for mobile terminals sold in various countries in which different languages are spoken. A plurality of these language packs also represents considerable amount of data to be stored on the mobile terminal.

Data storage capacity is limited on mobile terminals due to the desire to construct these devices compact and light. Other applications on the mobile terminals also require data storage capacity, and therefore, it is desirable to use the available data storage capacity efficiently.

U.S. Pat. No. 4,500,955 discloses a word processing system to which a dedicated word table is added for allowing words to be saved as references to the table in order to reduce storage space and transmission time. It is however not attractive to add a dedicated word table to a mobile terminal in several languages since these word tables itself will consume considerable storage space.

### DISCLOSURE OF THE INVENTION

On this background, it is an object of the present invention to provide a mobile terminal of the kind referred to initially, that uses the available data storage capacity more efficiently. This object is achieved by a mobile terminal comprising a display; means for entering text; a predictive editor program for generating an output containing words completing a received string of ambiguous keystrokes or matching a received string of ambiguous key strokes, the predictive editor program has a number of associated vocabularies including at least one language dependent dictionary; at least one further program that is capable of compressing text data by replacing words with references to the language dependent dictionary and/or capable of decompressing text data by retrieving words from the language dependent dictionary using references to the language dependent dictionary.

Most text data is stored using the 7 bit ASCII code that can represent 2⁸ or 256 characters with each character coded by a unique 8 bit representation. Thus, a five character word placed in data storage requires 35 bits of information. In text transmission, a start bit, a stop bit are normally added to the character code for each character. Thus, that same five character word requires 5 times 10, i.e. 50 bits of information when it is transmitted.

With the present invention whole words are directly coded as references to the language dependent dictionary rather than of coding each of the characters that make up the particular alphanumeric word. This allows for reduction of storage space and decreases text transmission time. For example, for a vocabulary set containing N words, one can code the N words with a binary code having log₂N bits. A choice of 14 bits per word results in a vocabulary set of 2¹⁴ or 16,384 words. Since each word in the vocabulary set consists of 14 bits regardless of the character count of the word, a significant reduction in storage space can be realized using this coding technique. A reduction will also be realized in text transmission time.

By using the language dependent dictionaries for both predictive editing of ambiguous input strings and for references for storing words the storage space for a dedicated word table is saved.

Preferably, the further program identifies words in data that is represented as a sequence of characters drawn from an alphabet in an input data block and processes it into an output data block in which character combinations that correspond to words contained in said language dependent dictionary are replaced by references to said language dependent dictionary.

The second program can save the words of the text as references to the language dependent dictionary and/or retrieve words from the language dependent dictionary using stored or received references.

It is also possible for the second program to send data incorporating references to said language dependent dictionary to other terminals and/or retrieve words from said language dependent dictionary through references from data received from other terminals.

The further program can be a terminal operation program, that has at least one associated language data set for outputting text to the display. Instead of character code the language data set contains references to the language dependent dictionary. Often three to seven languages are supported on a mobile terminal, so that the compression can be applied to up to seven language packs.

The further program can also be a program for storing and retrieving text messages to and from the mobile terminal. The program stores words contained in the text messages as references to the language dependent dictionary and retrieves words of the text messages from the language dependent dictionary using stored or received references.

The further program can be a message handling program that sends text messages to other terminals, preferably PCs, servers or mobile phones, whereby the text message contains references to the language dependent dictionary.

Alternatively, the further program can be an application program interface (API) that stores downloaded text data as references to the language dependent dictionary.

The further program can be a calendaring or task management program that stores text entries as references to the language dependent dictionary.

The further program can also be a synchronization program for synchronizing data such as calendar entries or tasks between the mobile terminal and other terminals that store text entries as references to the language dependent dictionary.

The further program can store the references on—or retrieves the references from a removable data carrier.

The references can direct references to addresses in said language dependent dictionary.

Alternatively, the references can be strings of key strokes through which the predictive editor program can retrieve the words to be used from said language dependent dictionary. Thus, the further software does not need to be capable of retrieving the words directly from the language dependent dictionary.

The means for entering text may comprise a keypad having a plurality of keys, preferably a plurality of keys associated with several letters each.

The keypad comprises discrete mechanical keys, and preferably a number of soft keys.

Typically, the keyboard layout for mobile phones is fixed to a 3*4 keypad with 10 alphanumerical keys associated with several letters or characters each plus two keys that are usually assigned to non-letter symbols. Since it is desirable for mobile phones to be pocket size, there is no space for more than a few more keys further to the nine alphanumerical keys. Typically, only 3 keys (one “softkey”, one “clear” key and one “navigation” or 5 keys (two soft keys, a “off-hook” key, an “on-hook” key and a navigation key) are further to the nine alphanumerical keys are present on the keypad of a mobile phone.

The keypad may comprise keys displayed on a touch screen.

The mobile terminal can be a communication terminal, preferably a mobile phone comprising processor means, memory means, digital signal processing means, RF transmitting and receiving circuitry, a microphone, and a speaker. The mobile phone can be provided with a SIM card or other removable card having storage capacity.

The mobile terminal can be a personal digital assistant (PDA).

Alternatively, the mobile terminal can be a combination of a mobile phone and a personal digital assistant. Such devices are often referred to as “communicators”.

It is another object of the invention to provide a method of compressing data in a mobile terminal. This object is achieved by providing a method comprising the steps of storing a language dependent dictionary on the mobile terminal; compressing text data on the mobile terminal replacing words in the text data with references to the language dependent dictionary and/or decompressing the text data by retrieving words from the language dependent dictionary using references to the language dependent dictionary.

The method can further comprise the steps of:

identifying words in text data that is represented as a sequence of characters drawn from an alphabet in an input data block;

processing said text data into an output data block in which character combinations in said text data that correspond to words contained in said language dependent dictionary are replaced by references to said language dependent dictionary.

The method may further comprise the steps of:

saving said output data block onto a fixed or removable memory of said mobile communication terminal;

and/or retrieving words from said language dependent dictionary through stored references.

The method may also comprise the steps of:

sending data incorporating references to said language dependent dictionary to other terminals and/or

retrieving words from said language dependent dictionary from references in data received from other terminals.

The method may further comprise the step of:

storing a language data set for a terminal operation program on said terminal, as references to said language dependent dictionary.

The method may further comprise the steps of:

storing words of text messages as references to said language dependent dictionary and/or

retrieving words of text messages from said language dependent dictionary using stored or received references.

The method may further comprise the step of:

sending text messages to other terminals, preferably PCs, servers or mobile phones, wherein words of said text message are stored as references to said language dependent dictionary.

The method may further comprise the steps of:

attaching a reference to the used language, and/or the used dictionary.

The text message can be sent to said other terminal via a dedicated terminal having a copy of said language dependent dictionary, whereby said dedicated terminal retrieves the words of said text message and passes the text massage on to said other terminal with the references replaced by the corresponding words as plain text.

Words not present in the dictionary are not replaced by references to the language dependent dictionary and character code, or if possible they are replaced by a plurality of references to parts of the word that are present in the language dependent dictionary.

The method may further comprise the step of:

retrieving words from said language dependent database through references received in text messages from other terminals, preferably PCs, servers or mobile communication terminals.

The method may further comprise the step of:

saving text data contained in files that are downloaded to the terminal as references to said language dependent dictionary.

The language dependent dictionary can be a dictionary associated with a predictive editing program that receives unambiguous keystrokes.

The language dependent dictionary can also be a dictionary associated with a predictive editing program that receives ambiguous keystrokes.

Alternatively, the language dependent dictionary is a dictionary associated with a spell checking function of a text editing program.

The references used in the method can be direct references to addresses in said language dependent dictionary.

Alternatively, the references used in the method can be strings of keystrokes through which the predictive editor program can retrieve the words to be used from said language dependent dictionary.

Further objects, features, advantages and properties of the mobile terminal and the method of compressing data according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 schematically illustrates a preferred embodiment of a hand portable phone according to the invention.

FIG. 2 schematically shows the essential parts of a telephone for communication with a cellular or cordless network.

FIG. 3 shows the major components of the predictive editor according to a preferred embodiment of the invention.

FIG. 4 shows the architecture of the phone software according to a preferred embodiment of the invention.

FIG. 5 illustrates a flow diagram for the compression routine according to the invention.

FIG. 6 illustrates a flow diagram for the decompression routine according to the invention.

FIG. 7 schematically illustrates an alternative embodiment of a hand portable phone according to the invention, and

FIG. 8 illustrates a sequence of displays illustrating the changing of a message setting from text format to compressed text format.

### DETAILED DESCRIPTION

In the following detailed description, a mobile terminal according to the invention in the form of a hand portable phone, preferably a cellular/mobile phone, will be described by the preferred embodiments.

The term “dictionary” as used here includes any type of word database. Such a word database may also include proper names, user entered words, acronyms, plural vocabularies, user vocabularies, etc.

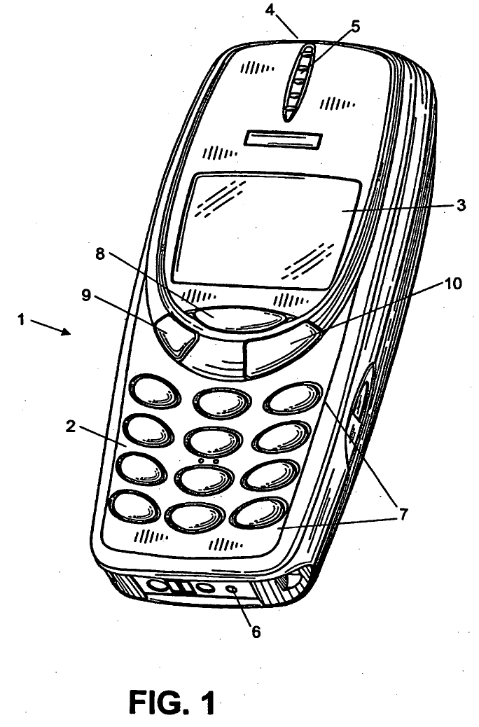

FIG. 1 shows a preferred embodiment of a phone according to the invention, and it will be seen that the phone, which is generally designated by 1, comprises a user interface having a keypad 2, a display 3, an on/off button 4 on the top of the phone (hidden in FIG. 1), a speaker 5 (only openings are shown in FIG. 1), and a microphone 6 (only opening is shown in FIG. 1). The phone 1 according to the preferred embodiment is adapted for communication via a cellular network, but could have been designed for a cordless network as well.

According to the preferred embodiment, the keypad 2 has a first group 7 of keys as discrete mechanical alphanumeric keys, a soft key 8, and a navigation key 10. Furthermore, the keypad includes a “clear” key 9. The present functionality of the soft key 8 is shown in a separate field in the display 3 just above the key 8. This key layout is characteristic of the Nokia 3310® phone and other Nokia® phones.

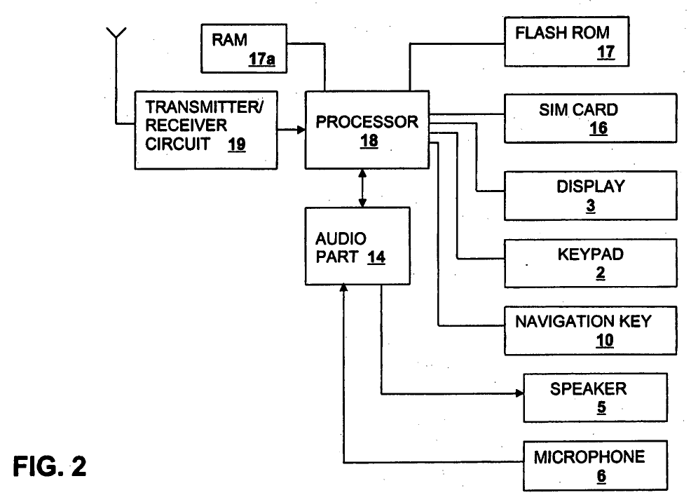

FIG. 2 schematically shows the most important parts of a preferred embodiment of the phone, said parts being essential to the understanding of the invention. The preferred embodiment of the phone of the invention is adapted for use in connection with the GSM 900 MHz and GSM 1800 MHz network, but of course, the invention may also be applied in connection with other phone networks. The processor 18 controls the communication with the network via the transmitter/receiver circuit 19 and an antenna 20 that will be discussed in details below.

The microphone 6 transforms the user's speech into analog signals, the signals formed thereby are A/D converted in an A/D converter (not shown) before the speech is encoded in an audio part 14. The encoded speech signal is transferred to the processor 18, which i.e. supports the GSM terminal software. The processor 18 also forms the interface to the peripheral units of the apparatus, including a RAM memory 17a and a Flash ROM memory 17b, a SIM card 16, the display 3 and the keypad 2 (as well as data, power supply, etc.). The audio part 14 speech-decodes the signal, which is transferred from the processor 18 to the earpiece 5 via a D/A converter (not shown)

Basic Operation of the Predictive Editor

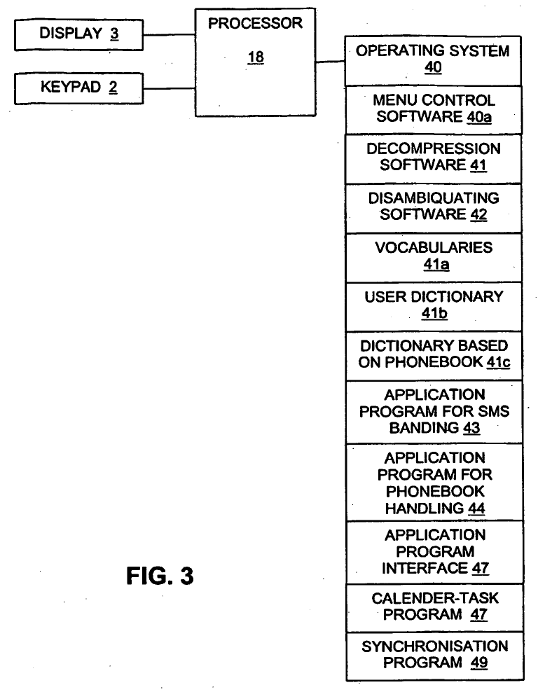

FIG. 3 shows the major components of the software on the mobile terminal according to the invention. The man-machine interface is established by the display 3 and the keyboard 2. The phone status is controlled by the menu control software 40a that displays commands and messages on the display 3 in a particular natural language. The menu control software is supported by at least one, but often three to seven language packs that comprise natural language data for the commands and messages used by the menu control software. The processor 18 executes instructions and reads and writes data from a memory 17. The software instructions in the memory 17 include an operating system 40, menu control software 40a, compression-decompression software 41, vocabularies 41a, b, c, disambiguation software 42, an application program for SMS banding 43, an application program for phonebook handling 44, an application program interface 47, a calendar tasks program 48 and a synchronization program 49.

Target applications programs 43, 44 for the predictive editor used in a handset include the electronic phone book memory, notepad, messages, calendar, and internet browsing.

The predictive editor is used as an alternative together with the standard multitap text editor used in handsets. This standard editor is also based on a plurality of keys each associated with several letters. However, the individual letter is selected by multi-pressing the key in question.

Data is entered on the keypad 2 which comprises individual alphanumerical keys 7. Most of these keys 7 have multiple meanings, represented by letters, numbers and symbols printed on the keys. The entered text is shown in the display 3 of the phone. The text already entered (and accepted by the user) is shown in the same text format as the standard display format of the phone. The word presently being entered is underlined or reversed in colors in order to indicate that the letter string has not been fixed yet. The predictive editor is able to interpret individual keys and multiple key sequences in several ways simultaneously.

The software on the terminal further comprises compression and a decompression software 41 that enables text messages to be compressed for saving and sending, and to decompress saved and received messages.

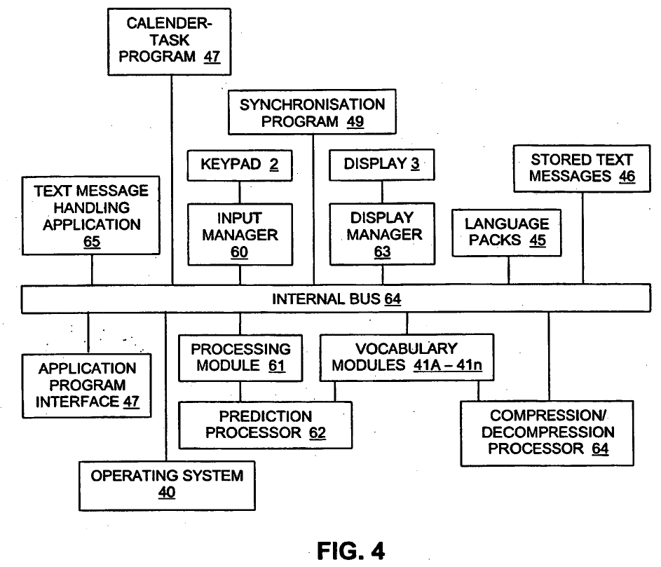

FIG. 4 shows the architecture of the disambiguating software. An input from a keypad 2 is processed in an input manager 60. Input data is via internal bus means 64 passed to a processing module 61, which keeps a record of the current key sequence until the user has accepted a word based on this sequence by pressing the space key or the navigation key 10 down. When a key stroke has been received by processing module 61, the current key sequence is communicated via internal bus means 64 to a prediction processor 62, which forwards the sequence to one or more modules 41 acting as electronic vocabularies. The vocabularies as such, or in combination, form a language dependent dictionary.

The vocabulary modules 41a, 41b, 41c, . . . 41N work in parallel and respond individually if they contain data matching the current key stroke sequence. One vocabulary module 41a might include a dictionary containing words in a language, e.g. English, defined by the user and used as editing language. According to the preferred embodiment, some of the vocabulary modules 41a, 41b, 41c, . . . 41N may contain personalized user defined words, e.g. entered by using the standard editor of the phone (when the predictive editor did not find the word the user was looking for) or by copying the names from the phonebook into one of the vocabulary modules. In the preferred embodiment vocabulary module 41b and 41c contains the word entered by the standard editor and word copied from the phonebook, respectively.

The vocabulary modules 41a, 41b, 41c, . . . 41N often supply a plurality of matching words—either being displayed or available through the selection list. The predication processor 62 accumulates a complete list of matching words for the selection list from all vocabulary modules 41a, 41b, 41c, . . . 41N. When the prediction processor 62 has finalized the processing, the processing module 61 transfers the selection list 50 to a display manager 63 and the display 3 via the internal bus means 64.

In most cases, the disambiguation software will work as an editor server and therefore pass data strings directly to another client or application program 43, 44 running on the processor 18, too. In this case the keypad 2, the input processor 60 and the display manager 63 will be integrated in the application program 43, 44 using the predictive editor as a server. These applications may include the electronic phone book memory, notepad, messages, calendar, and internet browsing.

Vocabulary Look-Up Processing

Vocabulary look-up processing is handled by a computer program being available on the market today. Therefore, these parts will not be described further. Both the disambiguation software and the basic dictionaries in a plurality of languages are available from e.g. Tegic Communications, Inc. under the trade name T9. The disambiguation software and the basic dictionaries (e.g. the English one) as well requires 100 kbyte memory space each.

The user defined directories are less memory consuming and only requires 2-4 kbyte each according to the preferred embodiment. These dictionaries work advantageously according to the first in first out principle.

The user interface for predictive editing is well known from e.g. the Nokia 3310® phone and its manuals (herby incorporated by reference) and will therefore not be described in details here.

Basic Operation of the Compression/Decompression Software

FIG. 3 shows that the compression/decompression software 41 runs under the operating system 40. The compression/decompression software 41 will work as an editor server and therefore pass data strings directly to another client or application program running on the processor 18, too.

The compression/decompression software 41 comprises a compression routine and a decompression routine.

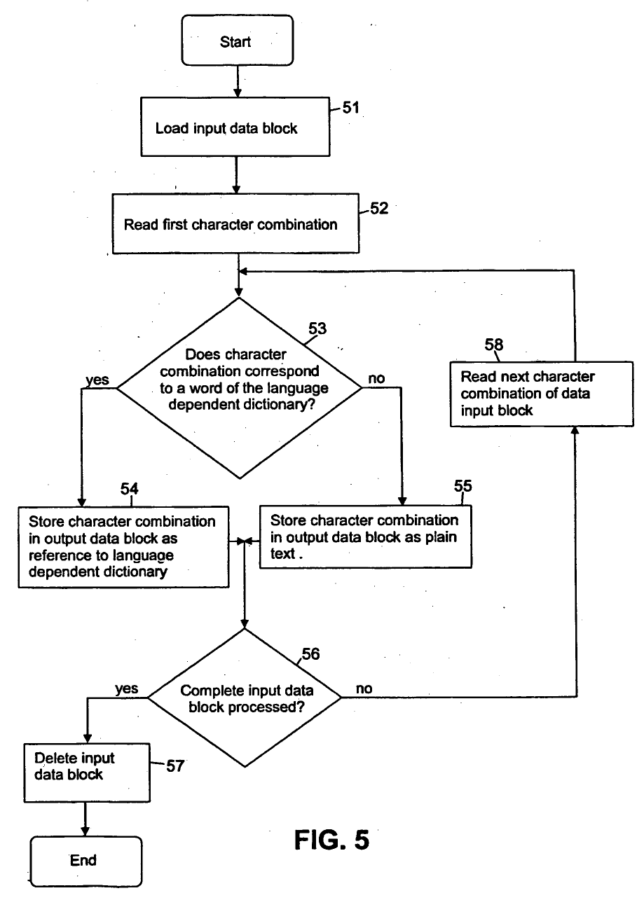

FIG. 5 shows the basic concept for the compression routine. An input data block (usually received from another application) is loaded in step 51. The input data block may contain text composed of alpha, numerical, punctuation characters, and any other symbols. The data block is preferably in the in ASCII format.

The first character combination of the input data block is read in step 52. The compression software 41 determines in step 53 whether the character combination corresponds to any word in the language dependent dictionary by looking up the character combination the vocabularies 41a, 41b, 41c, . . . 41N.

When the character combination is present in the language dependent dictionary, a reference to the corresponding address in the language depended dictionary is saved to an output data block.

Character combinations in the input data block that are not present in the language dependent dictionary are stored in the output data block as plain text (character code) without compression.

The compression software checks whether the last character combination of the input block has been processed in step 56. When this is not the case, the next character combination of the input data block is read in step 58 and the procedure of steps 53,54,55,56 and 58 is repeated until all the character combinations of the input data block have been processed. Then the input data block is deleted and the compression routine ends.

The compression routine can be a server for any other software applications on the phone 1. The input data block can be a composed or received text message for which the message handling application 65 requests compression before saving or sending. The text messages can have e-mail, SMS, MMS or MIME or any other presently available or future message format. The message handling program may attach a reference to the language and/or the particular language dependent dictionary that has been used for compression of the text data, so that software in the recipient terminal may easily recognize which language and which language dependent data base is to be used to decompress the compressed data.

The input data block can be received from an application program interface (API) for compressing downloaded texts. Other applications that can provide input data blocks to the compression routine comprise calendaring programs, task management programs, programs for synchronization of data on the phone with a PC and any other applications that handle, store or receive data containing text.

The output data block is either saved to the RAM 17 or to the SIM card 16. Alternatively, the output data block can be saved to another removable data carrier such as a memory stick or a compact flash card (not shown).

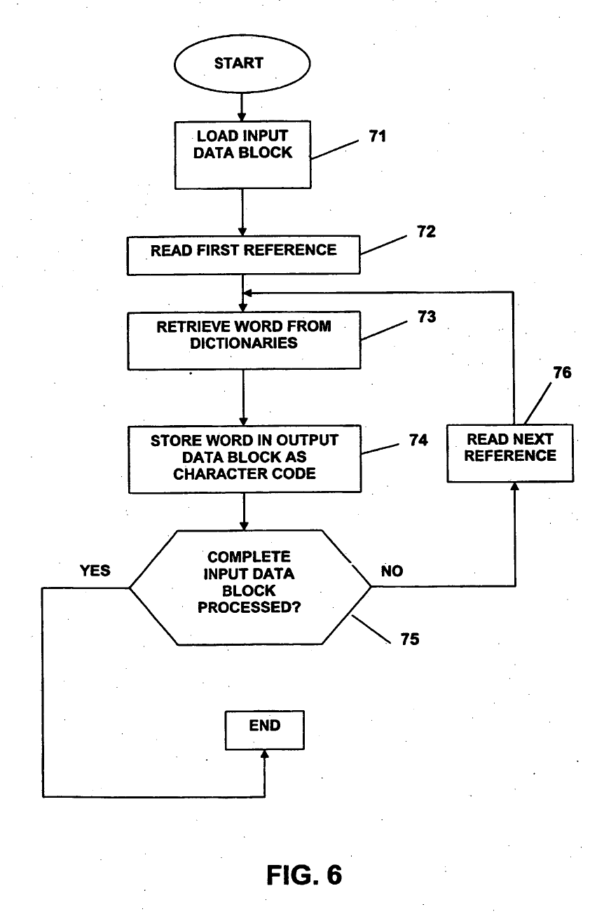

FIG. 6 shows the basic concept for the decompression routine. An input data block containing references to the language dependent dictionary is loaded in step 71. The compression/decompression software 41 reads the first reference in step 72. The reference is looked up and the corresponding word is retrieved in step 73. The retrieved word is stored in the data output block as plain text (character code). If the input data block contains plain text, the plain text is copied into the data output block and the next reference is read.

The compression/decompression software 41 checks in step 75 whether the complete input data block has been processed. If this is not the case, the next reference in the data input block is read in step 76, and steps 73,74,75 and 76 are repeated until the complete data input block has been processed. When all the references have been read, the decompression routine ends.

The decompression routine can be a server for any other software applications on the phone 1. The input data block can be a stored or received compressed text message for which the message handling application 65 requests decompression for showing the compressed message on the display 3. The compressed text messages can have e-mail, SMS, MMS or MIME or any other presently available or future message format.

The decompression routine can also be a server to the menu control software 40a for decoding language packs 45. The input data block contains references that were stored in a language pack for the menu control software 40a. The language pack comprises text (commands, messages), predictive editor vocabularies and dictionaries, fonts, sorting tables, ringing tunes an graphics. The text part of language packs are stored on the phone 1 in a compressed format using references to the language dependent dictionary. When the menu control software 40a needs to show a word or a sentence on the display 3, it produces a data input file containing references into the language dependent dictionary which is sent to the decompression routine of the compression/decompression software 41. The decompression routine returns a data output block containing the required plain text for use by the menu control software 40a.

Other applications that can send input data blocks to the decompression routine comprise calendaring programs, task management programs, programs for synchronization of data on the phone with a PC and any other applications that handle, store or receive data containing text. The text data to be decompressed can be data that has been saved, received (SMS, MMS, XHTML), downloaded (cable, IrDA, WAP, Bluetooth) or factory installed to the phone.

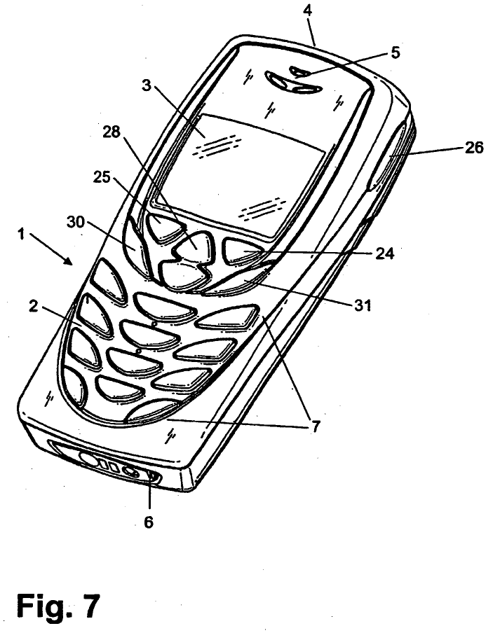

FIG. 7 shows another preferred embodiment of a phone according to the invention. Instead of one softkey 8, the correction key 9 and the navigation key 10 of the previous embodiment, the phone 1 comprises an “on-hook” key 30, an “off-hook” key 31, a first softkey 24, a second softkey 25, and a navigation key 28. The phone is further provided with a volume control key 26 on the side of the phone. The other features of this phone are substantially identical to the phone according to the first preferred embodiment. This key layout is characteristic of the Nokia 8310® phone and other Nokia® phones

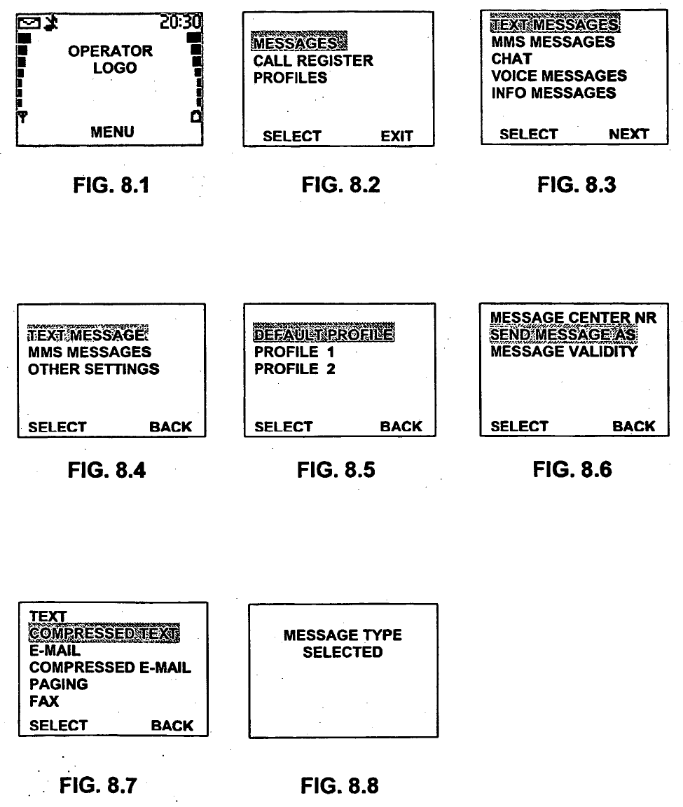

With reference to FIG. 8, the procedure of setting the format for text messages on the mobile phone with a layout having two softkeys 24,25 is explained. The menu control software 40a presents a display as shown in FIG. 8.1 as the normal state. By pressing softkey 25 “Menu” the display changes to the state shown in FIG. 8.1. By using the navigation key 28, the user can scroll thought the available menu items that may include: Messages, Call register, Profiles, Settings, Alarm Clock, Calendar, Games, Services and others. Using the softkey “Select” when “Messages” is highlighted brings the display to the state shown in FIG. 8.3. The display now lists a number of navigation key scrollable items including: Text messages, Multimedia msgs., Chat, Voice messages, Info messages, Message settings, and Service commands. Using the navigation key 28 and selecting “Message settings” with softkey 25 brings the display to the state shown in FIG. 8.4. The display lists the scrollable items: Text messages, Multimedia msgs., and Other settings. Selecting “Text messages” using the softkey 25 brings the display to the state shown in FIG. 8.5. The display lists the scrollable items: Default profile, Profile 1, and Profile 2. Selecting e.g. Default profile brings the display in the state shown in FIG. 8.6. The display lists the scrollable items: Message center number, Message sent as, Message validity, Delivery reports, Default recipient Number, and Use GPRS. Selecting “Message sent as” brings the display to the state as shown in FIG. 8.7. The display now lists the scrollable items: Text, Compressed text, E-mail, Compressed e-mail, Paging, and Fax. By selecting “Compressed text” the user can set the standard format for sent text messages to the compressed format. After selecting “Compressed text” the display turns to the state shown in FIG. 8.8 and displays for a short while the confirmation message “Message type selected”, then the display turns to the state of FIG. 8.6. Selecting the softkey 24 “back” four times and selecting the softkey 24 “Exit” once brings the display back to the normal state shown in FIG. 8.1.

The embodiments above are based on the principle of compressing text data by converting character combinations to direct references (addresses) into the language dependent dictionary. It is however also possible to use indirect references to the language dependent dictionary. In the above example of the dictionary associated with a predictive editor for disambiguating ambiguous keystrokes, it would be possible to use keystroke combinations as references. The keystroke combination would be those combinations that a user would enter when attempting to type the word. The reference (keystroke combination) is sent to the prediction processor 62 which retrieves the word from the language dependent dictionary. The prediction processor could thus be used as the decompression routine for retrieving the words from the language dependent dictionary.

Although the invention has been shown on a mobile phone with a predictive editor based on ambiguous keystrokes, it is understood the invention equally applies to any mobile terminal that includes a language dependent dictionary. These can e.g. be dictionaries associated with predictive word completing editors for unambiguous keystrokes (multitap), spelling dictionaries.

According to another preferred embodiment of the invention the mobile terminal is a personal digital assistant (PDA), e.g. a PDA (not shown) including processor means, memory means, a touch screen for text input using a pen (graffiti) and predictive text editing software for automatic completing of words based on a partial input, and a language dependent dictionary associated with said predictive editing software. Applications that use the compression include word processing software, calendar software, address books, menu control applications, e-books, and any other applications that handle or store data containing text.

Of course it is also possible to apply the present invention to terminals that are a combination between a mobile phone and a PDA, so-called communicators.

Although the present invention has been described in detail for purpose of illustration, it is understood that such detail is solely for that purpose, and variations can be made therein by those skilled in the art without departing from the scope of the appended claims.

1. A mobile terminal comprising:
a display;
means for entering text;
a predictive editor program for generating an output containing words completing a received string of ambiguous keystrokes or matching a received string of ambiguous keystrokes, said predictive editor program has a number of associated vocabularies forming a language dependent dictionary;
characterized by comprising
at least one further program that is capable of compressing text data by replacing words with references to said language dependent dictionary and/or capable of decompressing text data by retrieving words from said language dependent dictionary using references to said language dependent dictionary.

2. A mobile terminal according to claim 1, characterized in that said further program identifies words in data that is represented as a sequence of characters drawn from an alphabet in an input data block and processes it into an output data block in which character combinations that correspond to words contained in said language dependent dictionary are replaced by references to said language dependent dictionary.

3. A mobile terminal according to claim 1, in which said second program saves the words in said text as references to said language dependent dictionary and/or retrieves words from said language dependent dictionary using stored or received references.

4. A mobile terminal according to claim 1, in which said second program sends data incorporating references to said language dependent dictionary to other terminals and/or retrieves words from said language dependent dictionary through references from data received from other terminals.

5. A mobile terminal according to claim 1, characterized in that said further program is a terminal operation program, said terminal operation program having at least one associated language data set for outputting text to the display, and said language data set contains references to said language dependent dictionary.

6. A mobile terminal according to claim 1, characterized in that said further program is a program for storing and retrieving text messages to and from said terminal and said program for storing and retrieving text messages stores words of said text messages as references to said language dependent dictionary and retrieves words of said text messages from said language dependent dictionary using stored or received references.

7. A mobile terminal according to claim 1, characterized in that said further program is a message handling program that sends text messages to other terminals, preferably PCs, servers or mobile phones, whereby said text message contains references to said language dependent dictionary.

8. A mobile terminal according to claim 1, characterized in that said further program is an application program interface (API) that stores downloaded text data as references to said language dependent dictionary.

9. A mobile terminal according to claim 1, characterized in that said further program is a calendaring or task management program that stores text entries as references to said language dependent dictionary.

10. A mobile terminal according to claim 1, in which said further program is a synchronization program for synchronizing data such as calendar entries or tasks between the mobile terminal and other terminals that store text entries as references to said language dependent dictionary.

11. A mobile terminal according to claim 1, characterized in that said further program stores said references on—or retrieves said references from a removable data carrier.

12. A mobile terminal according to claim 1, characterized in that said references are direct references to addresses in said language dependent dictionary.

13. A mobile terminal according to claim 1, characterized in that said references are strings of keystrokes through which the predictive editor program can retrieve the words to be used from said language dependent dictionary.

14. A mobile terminal according to claim 1, characterized in that said means for entering text comprises a keypad having plurality of keys, preferably a plurality of keys associated with several letters each.

15. A mobile terminal according to claim 14, characterized in that said keypad comprises keys displayed on a touch screen.

16. A mobile terminal according to claim 14, characterized in that said keypad comprises discrete mechanical keys, and preferably a number of soft keys.

17. A mobile terminal according to claim 1 characterized in said mobile terminal is a communication terminal, preferably a mobile phone comprising processor means, memory means, digital signal processing means, RF transmitting and receiving circuitry, a microphone, a speaker and preferably a SIM card or other removable card having storage capacity.

18. A mobile terminal according to claim 1, characterized in that said mobile terminal is a personal digital assistant (PDA).

19. A mobile terminal according to claim 1, characterized in that said mobile terminal is a combination of a mobile phone and a personal digital assistant.

20. A method of compressing data in a mobile terminal comprising the steps of:
storing a language dependent dictionary on said mobile terminal;
characterized by:
compressing text data on said mobile terminal by replacing words in said text data with references to said language dependent dictionary and/or
decompressing text data by retrieving words from said language dependent dictionary using references to said language dependent dictionary.

21. A method according to claim 20, further comprising the steps of:
identifying words in text data that is represented as a sequence of characters drawn from an alphabet in an input data block;
processing said text data into an output data block in which character combinations in said text data that corresponds to words contained in said language dependent dictionary are replaced by references to said language dependent dictionary.

22. A method according to claim 20, further comprising the steps of:
saving said output data block onto a fixed or removable memory of said mobile communication terminal;
and/or retrieving words from said language dependent dictionary through stored references.

23. A method according to claim 20, further comprising the steps of:
sending data incorporating references to said language dependent dictionary to other terminals and/or
retrieving words from said language dependent dictionary from references in data received from other terminals.

24. A method according to claim 20, further comprising the step of:
storing a language data set for a terminal operation program on said terminal, as references to said language dependent dictionary.

25. A method according to claim 20, further comprising the steps of:
storing words of text messages as references to said language dependent dictionary and/or
retrieving words of text messages from said language dependent dictionary using stored or received references.

26. A method according to claim 20, further comprising the steps of:
sending text messages to other terminals, preferably PCs, servers or mobile phones, wherein words of said text message are stored as references to said language dependent dictionary.

27. A method according to claim 20, further comprising the step of:
attaching a reference to the used language, and/or the used dictionary.

28. A method according to claim 27, wherein said text message is sent to said other terminal via a dedicated terminal having a copy of said language dependent dictionary, whereby said dedicated terminal retrieves the words of said text message and passes the text message on to said other terminal with the references replaced by the corresponding words as plain text.

29. A method according to claim 20, in which words not present in the dictionary are not replaced by references to the language dependent dictionary and remain plain text, or if possible are replaced by a plurality of references to parts of the word that are present in the language dependent dictionary.

30. A method according to claim 20, further comprising the step of:
retrieving words from said language dependent database through references received in text messages from other terminals, preferably PCs, servers or mobile communication terminals.

31. A method according to claim 20, further comprising the step of:
saving text data contained in files that are downloaded to the terminal as references to said language dependent dictionary.

32. A method according to claim 20, wherein said language dependent dictionary is a dictionary associated with a predictive editing program that receives unambiguous keystrokes.

33. A method according to claim 20, wherein said language dependent dictionary is a dictionary associated with a predictive editing program that receives ambiguous keystrokes.

34. A method according to claim 20, wherein said language dependent dictionary is a dictionary associated with a spell checking function of a text editing program.

35. A method according to claim 20, wherein said references are direct references to addresses in said language dependent dictionary.

36. A method according to claim 33, wherein said references are strings of keystrokes through which the predictive editor program can retrieve the words to be used from said language dependent dictionary.

37. A method according to claim 20, wherein said mobile terminal is a communication terminal, preferably a mobile phone comprising processor means, memory means, digital signal processing means, RF transmitting and receiving circuitry, a microphone, a speaker and preferably a SIM card or other removable cards having storage capacity.

38. A method according to claim 20, wherein said mobile terminal is a personal digital assistant (PDA).

39. A method according to claim 20, wherein said mobile terminal is a combination of a mobile phone and a personal digital assistant.
